(19) United States
(12) Patent Application Publication
(10) Pub. No.: US 2002/0194742 A1
(43) Pub. Date: Dec. 26, 2002

(54) Wheel alignment device

(76) Inventor: Liam Venter, Auckland (NZ)

Correspondence Address: YOUNG & THOMPSON, 745 SOUTH 23RD STREET 2ND FLOOR, ARLINGTON, VA, 22202

(21) Appl. No.: 10/153,816

(22) Filed: May 24, 2002

(30) Foreign Application Priority Data
May 24, 2001 (NZ) 512001

(51) Int. Cl. G01B 5/24

(52) U.S. Cl. 33/203.18

(57) ABSTRACT

The present invention consists in a wheel alignment apparatus. The apparatus has two subassemblies which are associated with a stub axle of a vehicle to have its wheels aligned. The apparatus also includes a datum bar member associated or associable with each of the subassemblies. In use, at least part of each of the subassemblies has a variable gap relationship to said datum bar member. Each of the subassemblies provides a calibratable measure of the angular disposition of the associated stub axle with the datum bar member whereby characterising its alignment.

### FIELD OF THE INVENTION

The present invention relates to apparatus and methods for the measurement of the alignment of the wheels of a vehicle, whether front or rear, and also their relativity to each other as a result of possible chassis twisting. The invention has been devised particularly though not necessarily solely for use in the kart or automobile industry.

### BACKGROUND ART

Wheel alignment systems useful for vehicles such as go-karts are known. They are designed to measure toe and camber changes which are commonly caused by placing the driver's weight in the kart. The website of J. Learmonth Racing Products discloses one such system (disclosed in Australian Registered Design No. 137478). This system uses a spacer bar with a 2-inch wide plate attached to each end perpendicular to the spacer bar. This plate is to be held against the stub axle and angular deflection is to be measured directly between the stub axle and the plate with a feeler gauge. This system, known as the ZERO TOE BAR™, also advocates placing the kart on axle stands while measurements are made. This ZERO TOE BAR™ product and its use has a number of disadvantages, namely:

a) The bar must be held in place by hand or by way of a large rubber band and is hence awkward to and unstable in use.

b) The bar in this system can not be wider than the stub axles otherwise the perpendicular plates can not sit on both stub axles at once. To accommodate the need to have this system work on different width karts the designer has made the bar to which the two flat plates are attached a two piece affair. One bar slides inside the other and these are held in place relative to each other in use with a thumbscrew. This introduces extra moving parts and tolerance into the system, which effects accuracy.

c) Unlike the present invention which has surfaces on which a leveling device (spirit level or other) may be positioned, there is no mechanism for ensuring that the flat plates are truly perpendicular to the axle/stub axles when measuring camber or likewise truly horizontal to the central axis of the axle/stub axle when measuring toe-in.

d) The present invention offers precise datum points and measuring surfaces. With the ZERO TOE BAR™ system there are no precise datum's for the feeler gauge to be inserted between. For example, how far in does a user insert the feeler gauge?

e) Nor does the designer suggest an accurate method of measuring for chassis twist with the apparatus.

f) Nor does the designer suggest a procedure for verification of the accuracy and trueness of the componentry.

### OBJECTION OF THE INVENTION

It is an object of the present invention to provide a wheel alignment system which will at least provide the public with a useful choice to such other systems or which will overcome at least one of the aforementioned disadvantages in a simple yet effective manner.

### BRIEF DESCRIPTIONS OF THE INVENTION

In a first aspect the invention consists in wheel alignment apparatus including first and second means each associable with a stub axle of a vehicle to have its wheels aligned, each of said first and second means having a reproducible relationship with its stub axle axis, and datum providing means associated with or associable with each of said first and second means to allow, in use, at least part of the first means associated with the datum providing means and at least part of the second means associated with the datum providing means,

wherein in use at least part of each of said first and second means has a variable gap relationship to said datum providing means,

the construction and arrangement being such that each of the first and second means provides a calibratable measure of the angular disposition of the associated stub axle with the datum whereby characterising its alignment.

In some preferred forms of the present invention each said first and second means comprise two surfaces parallel to each other and orthogonal to a stub axle, once associated therewith.

In some preferred forms of the present invention each parallel surface is substantially accurately and repeatably spaced from the other and can be a subassembly, a first part or parts of which can be associated with the stub axle and thereafter associated with another subassembly thereof itself attached to or attachable to said datum providing means.

Preferably on at least one section of the periphery of first said means is located an edge, or edges, that is parallel and congruent with an edge, or edges, on the periphery of said second means.

In the preferred form of the present invention said datum providing means takes the form of a datum bar member with at least two coincidental parallel surfaces at each end which are associable with the abovementioned edge or edges of the parallel plates.

Preferably a second set of subassemblies, or at least one thereof, can be associated with a second axle, or set of axles, to allow inference to be drawn regarding the relative position of said first axle(s) to said second axle(s), or any connecting member there between.

Preferably each said means associable with a stub axle associates by receiving the stub axle there through.

In a second aspect the present invention consists in a method of checking and/or adjusting a vehicle for any one or more of the following:

the toe-in (or toe-out) of the front or rear sub stub axles,

the positive or negative camber of the front, or rear, stub axle or axles,

the twist in the chassis of the vehicle relative to the front or rear axles.

the straight line intersecting the two front wheel centres is parallel to the straight line intersecting the two rear wheel centres.

In a further aspect the present invention consists in a method of checking and/or adjusting a vehicle which includes the steps of

providing first and second means each associable with at least one axle of a vehicle to have its wheels aligned,

providing a datum providing means associated with or associable with each of said first and second means,

measuring a gap between at least one of the first or second means and said datum providing means to determine alignment of the axle.

Preferably the axle comprises stub axle.

Preferably the method of checking and/or adjusting a vehicle includes the further steps of adjusting the axle to alter the gap to a desired dimension corresponding to a desired alignment.

In a still further aspect the present invention consists in wheel alignment apparatus including first and second means each associable with at least one axle of a vehicle to have its wheels aligned,

datum providing means associated with or associable with each of said first and second means,

wherein in use at least part of each of said first and second means has a variable gap relationship to said datum providing means,

the construction and arrangement being such that each of the first and second means provides a measure of the angular disposition of the associated axle with the datum whereby characterising its alignment.

To those skilled in the art to which the invention relates, many changes in construction and widely different embodiments and applications of the invention will suggest themselves without departing from the scope of the invention as defined in the appended claims. The disclosures and the description herein are purely illustrative and are not intended to be in any sense limiting.

One preferred form of the present invention will now be described with reference to the accompanying drawing in which,

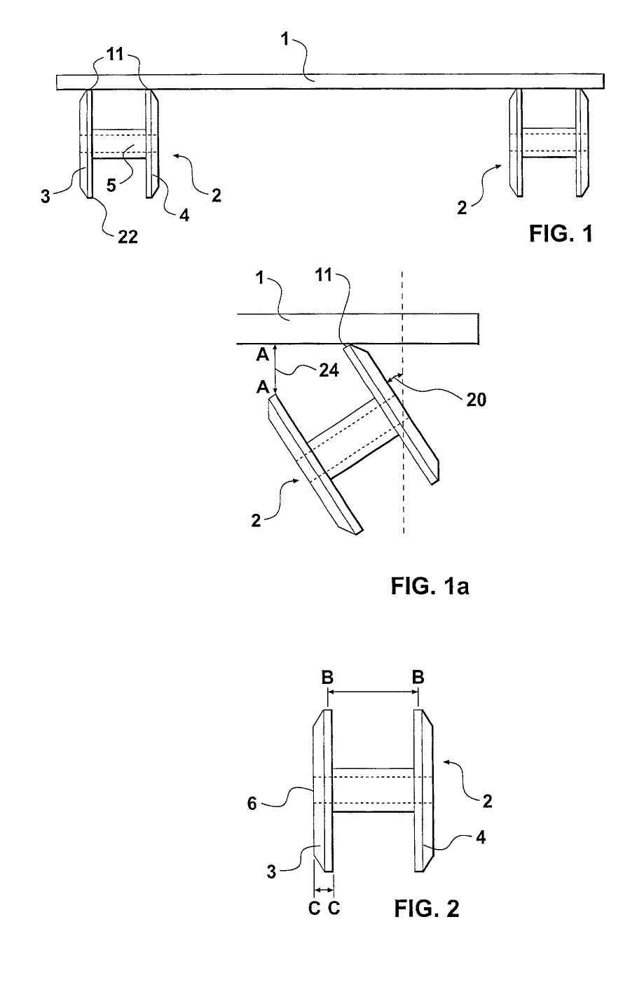

FIG. 1 is a front elevation of the preferred apparatus in accordance with the present invention.

FIG. 1a is a schematic diagram illustrating the disposition of the subassembly of FIG. 1 when in use.

FIG. 2 is front elevation of the subassembly of FIG. 1.

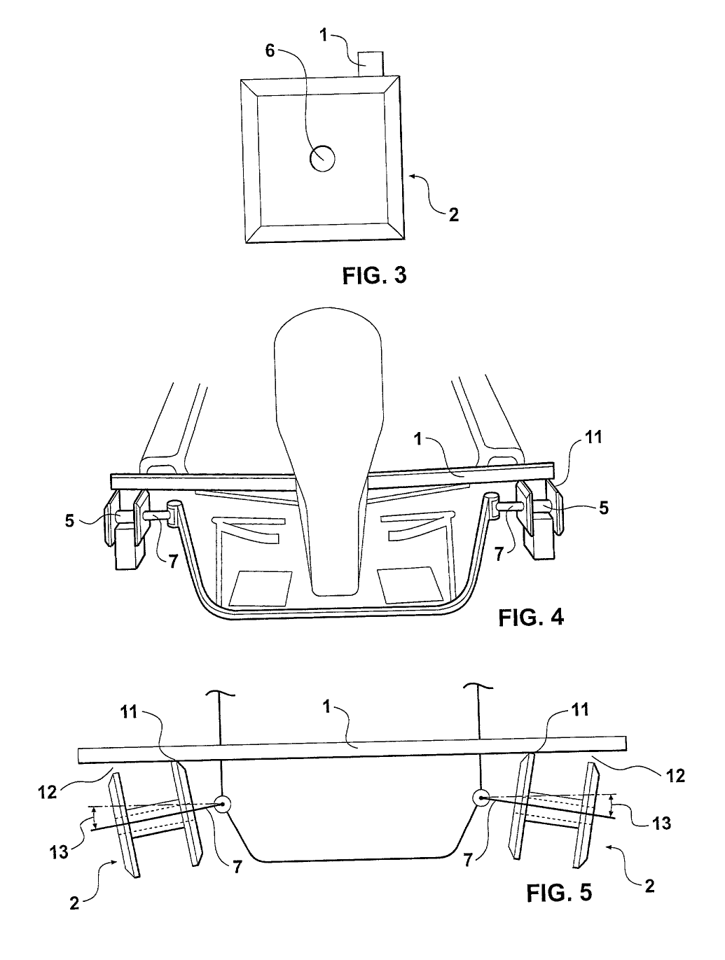

FIG. 3 illustrates an end elevation of the apparatus shown in FIGS. 1 and 2.

FIG. 4 shows a front perspective view of the apparatus installed on a vehicle.

FIG. 5 depicts a plan schematic of the preferred form of the present invention as utilised to adjust the toe-in of the vehicle.

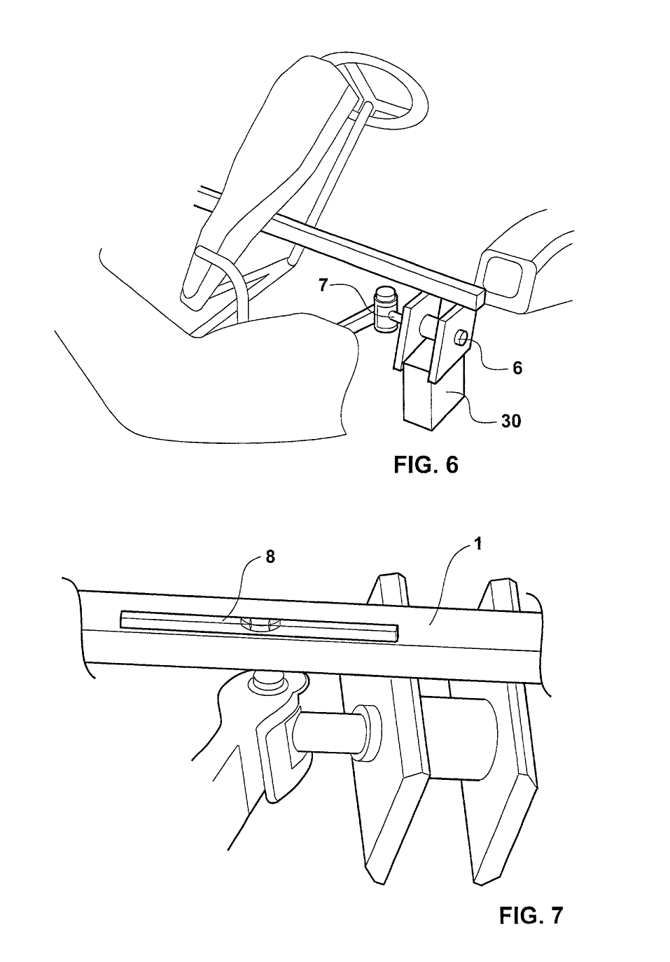

FIG. 6 is a perspective view of the preferred embodiment of the present invention attached to the front axles of a vehicle.

FIG. 7 shows the use of a spirit level in conjunction with the apparatus depicted in FIG. 1.

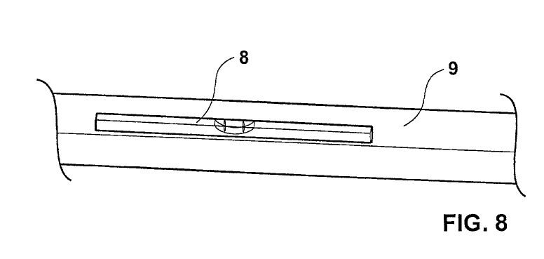

FIG. 8 shows the use of a spirit level in conjunction with the rear axle of a vehicle.

### DETAILED DESCRIPTION

With reference to FIG. 1 there is shown a substantially straight datum member 1 located in relationship to, substantially abutting, indicating edges 11 of subassemblies 2. The indicating edges 11 are designed to provide a precise datum point, which may be sharp, rounded or planar, to facilitate landing of the subassemblies 2. The indicating edges 11 include a chamfered rim 22. The subassemblies 2 each consist of two parallel plates 3 and 4 separated by a datum spacer 5 of known length. When either, or both of the subassemblies 2 are moved out of perpendicular alignment with datum member 1, a gap 24 will form on one indicating edge of each subassembly as shown schematically in FIG. 1a. The gap 24 (represented by A-A) created is directly proportional to the angle 20 of which the subassembly is moved away from the perpendicular.

The configuration of the subassemblies 2 are shown in FIG. 2. It should be contemplated that the distance represented by B-B provides a gap (represented by A-A in FIG. 1a) that conveniently relates or corresponds to angle 20 in a manner that allows angle 20 to be readily determinable without requiring computation or calculation. The plates 3 and 4 are preferred to be, but are not restricted to, 10 mm thick (represented by C-C). The width of the planar edges 11 are preferred to be 1.5 mm in order to provide a substantially precise datum point for a thickness measuring device, such as but not limited to a feeler gauge (not shown), to be probe into the gap 24.

Referring back to FIG. 1, there shows the datum member 1 abutting subassemblies 2, illustrating the subassemblies 2 aligned parallel to each other with all the indicating edges 11 abutting the datum member 1. Hence the relationship between subassemblies 2 and datum member 1 denotes zero degrees of camber.

FIG. 3 is an end elevation of the subassembly 2. In the present embodiment of the device, a mounting passage 6 through which an axle or stub axle (depending on the design of the vehicle, some vehicles have only one axle each for the front wheels and the back wheels respectively, whilst some other vehicles have two stub axles instead of one axle each for the front wheels and the back wheels respectively) is located can be used to secure the subassembly 2 for subsequent measuring and adjustment. With the mounting method described herein, the diameter of the mounting passage 6 has been designed to snugly but not loosely receive and accommodate the axle or stub axles such that no sliding or wobbling of the subassemblies 2 may occur. Alternative methods of disposing or fixing the subassemblies 2 to be associated with the axle or stub axles or the centre line of the axle(s) are envisaged but not illustrated.

Depicted in FIG. 4 is the apparatus shown in FIGS. 1 through 3 mounted on a suitable vehicle, in this case a racing kart. While FIG. 4 shows the use of the subassemblies 2 and datum member 1 on the front of the vehicle, all procedures and usage described herein are equally applicable to usage on the rear axle or axles of the vehicle. The subassemblies 2 are mounted onto the stub axles 7, together with the datum spacer 5. The methodology and mechanism of associating the subassemblies 2 with the axle or stub axles may vary. The subassemblies 2 may have clamps, brackets or other fastening means instead of the mounting passage 6. The indicating edges 11 of each of the subassemblies 2 can be seen and are parallel and congruent (in this form of the invention there are four sets of parallel and congruent edges, located around the periphery, per subassembly) with each other. The datum member 1 is placed across the subassemblies 2. The steering assembly is then manipulated (eg. using the steering wheel) to a position where the kart would be travelling in a straight line and held in that position. The kart may be set up in a number of ways for adjustment. A stand may be used to support the kart chassis. Alternatively, the subassemblies 2 may be supported on stands, such as wooden blocks. The level of the chassis can be determined reasonably accurately by placing the datum member 1 across the top of the subassemblies then placing a spirit level on the datum member. If the surface on which the kart is located is relatively level, then blocks of the same size may be used. If the surface is not sufficiently level, then one block may need to be propped up, or replaced by a different sized block. Adjustment can then begin. Having the kart level is not essential to achieving substantially accurate measurements.

Depicted in FIG. 5 is the datum member 1 abutting the subassemblies 2, when viewed from above, in a manner that will allow measurement and adjustment of axle toe-in or toe-out. In particular the angle 13 of each axle can be assessed in this way by measuring the resulting gap 12 that is created between one of the indicating edges 11 and the datum member 1. The dimensions of datum spacer 5 are selected such that the gap 12 conveniently relates or corresponds to an angle 13 in a manner that allows angle 13 to be readily determinable without requiring computation. This is advantageous in that only the size of the gap, which can be easily measured by a feeler gauge (not shown), has to be found for both measuring and adjusting toe-in or toe-out angles.

FIG. 6 depicts a preferred form of the present invention from a perspective front view. In particular, the association of the stub axle 7 with the passageway 6 through the subassembly can be seen. In this particular arrangement the camber of the wheels can be checked and/or adjusted in a manner similar to that described for toe measurement and adjustment. Basing on the same principle, the datum member 1 is transported to and disposed in a position that is 90 degrees to its original position about the axle, abutting the top horizontal indicating edges 11 of the subassemblies 2 for measuring and the adjustment of the camber (instead of abutting the vertical edges for carrying out toe-in measurement). It should be noted that subassembles 2 are not required to be removed, refitted or readjusted between these two measurement assemblies.

In FIGS. 7 and 8 the use of spirit levels 8 on the front datum member 1 and on a rear datum member 9 provided at the rear of the chassis, allow the amount of chassis twist of the rear relative to the front to be measured to indicate the degree of alignment of the rear of the chassis to the front. Optionally, association of a second set of subassemblies (not shown) to the rear axle or stub axles (not shown) together with a second datum member (which essentially is a rear datum member) would provide a rear datum. Alternatively the rear axle itself in some vehicles can serve as the datum member 9.

Checking That the Front and Rear Axles are Parallel

This can be achieved by fitting subassemblies 2 to the front and rear axles, and then placing the datum members 1 in the position as described for measuring toe. A first measurement can then be made between one end of the front datum member and the same end of the rear datum member. A second measurement is then made between the opposite end of the front datum member and of the rear datum member. If both the first and second measurements are identical this indicates that the front and rear axles are parallel to each other in plan view.

Measuring and Setting Camber and Toe settings

The following description of use details usage on a kart. The same procedures are applicable to other vehicle types.

In use, it needs to be ensured that there is no free play in any of the steering, camber, toe, pivot or castor mechanisms. While the kart is on the stand, the wheels are removed and the axles 7 are engaged with the subassemblies 2 with the ‘sacrificial’ edge down and disposed substantially parallel to the ground. The ‘sacrificial’ edge should always be used as the base. The kart is then placed on level ground resting on the subassemblies 2 on wooden axle stands provided. The axle stands 30 as shown in FIG. 6 can be made out of aluminimum or engineering plastics. It was discovered that wooden stands are advantageous in that they provide a higher degree of friction which prevents the steering moving around while measurements and adjustments are made. The tie rods are then loosened so that they can be freely adjusted. The steering wheel is then adjusted and fastened so that it is in the straight ahead position. The datum member 1 is then placed across the front (or the back when necessary) of the subassemblies (as shown in FIG. 5) and the gap between the front face of the subassemblies 2 and the datum member 1. It should be borne in mind that the size of the gap 12 is directly proportional to the toe-in or out angle. The tie rods are then adjusted until the desired toe-in or toe-out is achieved. The tie rods should not be tightened until the camber is also checked and set. In order to do that, the subassemblies 2 are placed between the top face of the subassemblies 2 and the datum member 1 and a gap measuring device is used to measure the gap between the top face of the subassemblies 2 and the data member 1. The camber is then adjusted until the desired camber is reached on each side of the kart. If the camber setting needs to be changed, the toe setting shall be re-adjusted by repeating step of placing the datum member 1 across the front of the subassemblies 2. Everything can then be tightened. The camber and toe should be re-checked to ensure that nothing has moved while tightening.

Checking for Chassis Twist

The first step is to set chamber and toe as detailed above. In use, it needs to be ensured that there is no free play in any of the steering, camber, toe, pivot or castor mechanisms. Any worn components should be replaced. The kart is then placed on the stand, and the front and rear wheels are replaced by the subassemblies 2. The datum member 1 is then placed across the top of the subassemblies 2 on which a spirit level (as shown in FIGS. 7 and 8) is provided and placed. The datum member 1 provides a substantially flat surface and a ‘virtual axle’ between the two front tyres. The same spirit level is then placed on the rear axle. The results are compared and any twist in the chassis will become apparent at this point.

Accuracy Verification

If at any stage it is believed that any component of the present invention has been bent out of true, simple steps can be taken to verify it's accuracy. The datum member 1 of the present invention is preferred to be made of aluminimum. Should a user suspects that this has become bent for any reason, a quick check can be performed. The datum member 1 can be turned 180 degrees and camber measurements can be made in the abovementioned way. If the camber or toe measurements remain unaltered this proves the bar is straight. Any alteration in the camber measurements proves that the bar has been bent. Likewise, the subassemblies can be turned over 180 degrees from their original position about the axle. If the measurements have not changed it proves that accuracy of the subassemblies 2 has not been compromised. The design offers the advantages of easy and ‘self’ accuracy verification without the aid of any other apparatus. It should however be noted that the subassemblies can take the form of other shapes and configurations so long as the gap can be measured conveniently and accurately, and a correlation between the gap 12 and the camber and toe-in (or out) angle is established so as to facilitate measuring and adjusting of the camber and toe.

Advantages

Thus it can be seen that at least in the preferred form of the invention an apparatus and a method for the measurement of the alignment of the wheels of a vehicle are provided which will offer the advantages of:

1. enabling simple, faster and higher accuracy camber and toe measurement and adjustment than the known systems (toe and camber can be achieved at better than plus or minus 0.2 degrees);

2. dispensing with a telescoping bar (or datum member);

3. dispensing with all moving parts that could develop or have free play in operation;

4. dispensing with graduation marks to wear off;

5. enabling checking for chassis twist;

6. enabling ‘self’ accuracy verification; and

7. being able to perform measurements with the driver's weight in the vehicle.

What we claim is:

1. In a first aspect the invention consists in wheel alignment apparatus including first and second means each associable with a stub axle of a vehicle to have its wheels aligned, each of said first and second means having a reproducible relationship with its stub axle axis, and datum providing means associated with or associable with each of said first and second means to allow, in use, at least part of the first means associated with the datum providing means and at least part of the second means associated with the datum providing means,
wherein in use at least part of each of said first and second means has a variable gap relationship to said datum providing means,
the construction and arrangement being such that each of the first and second means provides a calibratable measure of the angular disposition of the associated stub axle with the datum whereby characterising its alignment.

2. A wheel alignment apparatus as claimed in claim 1, wherein each said first and second means comprise two surfaces parallel to each other and orthogonal to a stub axle, once associated therewith.

3. A wheel alignment apparatus as claimed in claim 1, wherein each parallel surface is substantially accurately and repeatably spaced from the other and can be a subassembly, a first part or parts of which can be associated with the stub axle and thereafter associated with another subassembly thereof itself attached to or attachable to said datum providing means.

4. A wheel alignment apparatus as claimed in claim 1, wherein on at least one section of the periphery of first said means is located an edge, or edges, that is parallel and congruent with an edge, or edges, on the periphery of said second means.

5. A wheel alignment apparatus as claimed in claim 1, wherein said datum providing means takes the form of a datum bar member with at least two coincidental parallel surfaces at each end which are associable with the abovementioned edge or edges of the parallel plates.

6. A wheel alignment apparatus as claimed in claim 1, wherein a second set of subassemblies, or at least one thereof, can be associated with a second axle, or set of axles, to allow inference to be drawn regarding the relative position of said first axle(s) to said second axle(s), or any connecting member there between.

7. A wheel alignment apparatus as claimed in claim 1, wherein each said means associable with a stub axle associates by receiving the stub axle there through.

8. A method of checking and/or adjusting a vehicle for any one or more of the following:
the toe-in (or toe-out) of the front or rear sub stub axles,
the positive or negative camber of the front, or rear, stub axle or axles,
the twist in the chassis of the vehicle relative to the front or rear axles.
the straight line intersecting the two front wheel centres is parallel to the straight line intersecting the two rear wheel centres.

9. A method of checking and/or adjusting a vehicle which includes the steps of providing first and second means each associable with at least one axle of a vehicle to have its wheels aligned,
providing a datum providing means associated with or associable with each of said first and second means,
measuring a gap between at least one of the first or second means and said datum providing means to determine alignment of the axle.

10. A method of checking and/or adjusting a vehicle as claimed in claim 9, the axle comprises stub axle.

11. A method of checking and/or adjusting a vehicle as claimed in claim 9, wherein the method includes the further step of adjusting the axle to alter the gap to a desired dimension corresponding to a desired alignment.

12. A wheel alignment apparatus including first and second means each associable with at least one axle of a vehicle to have its wheels aligned,
datum providing means associated with or associable with each of said first and second means,
wherein in use at least part of each of said first and second means has a variable gap relationship to said datum providing means, capable of accurate feeler gauge probing between said datum providing means,
the construction and arrangement being such that each of the first and second means provides a measure of the angular disposition of the associated axle with the datum whereby characterising its alignment.
